(19) United States
(12) Patent Application Publication
(10) Pub. No.: US 2010/0321701 A1
(43) Pub. Date: Dec. 23, 2010

(54) Two optical media two sectional L-shaped double parallel beams interferometer

(76) Inventor: Rudolf Vrnoga, Chico, CA (US)

Correspondence Address: RUDOLF VRNOGA, 1106 WEST 8TH AVE, #10, CHICO, CA, 95926, US

(21) Appl. No.: 12/802,178

(22) Filed: Jun. 1, 2010

Related U.S. Application Data
(60) Provisional application No. 61/269,336, filed on Jun. 22, 2009.

(51) Int. Cl. G01B 9/02

(52) U.S. Cl. 356/450

(57) ABSTRACT

One embodiment of two optical media two sectional L-shaped double parallel beams interferometer, providing means and methods for neutralizing the negative impacts of Fitzgerald-Lorentz contractions, and Sagnac effect on experimental results, especially in the applications of experimental detection and confirmation of existence of ether. Experiments are based on observing and registering the shifts of interference fringes provoked by differences in influence of ether's wind on two parallel unidirectional crossed laser beams traveling through two L-shaped optical paths combined of two different optical media. Related to azimuthal orientations and geo-positions of experimental equipment, experimental outcomes are highly predictable from non-relativistic position, whereas they are not explicable from the relativistic position. Other embodiments are described and shown.

### CROSS-REFERENCE TO RELATED APPLICATIONS

This application claims the benefit of provisional application Ser. No. 61/269,336, filed Jun. 22, 2009 by the present inventor.

### FEDERALLY SPONSORED RESEARCH

None

### SEQUENCE LISTING

None

### BACKGROUND

1. Field

This is related to interferometers, specifically to two optical media two sectional L-shaped double parallel beams interferometers providing means and method for detection of presumed existence of hypothetical cosmical medium named ether, which fills all space of the Universe.

2. Prior Art

A hundred years ago, and more, there were performed numerous experiments to confirm existence of the ether, and to determine its properties. Especially were famous experiments of A. A. Michelson and E. W. Morley starting 1881 and repeated numerous times through almost two decades. FIG. 1 shows basic structure of a Michelson-Morley's interferometer. The light beam from monochromatic light source 101 is split by a beam-splitter 102 into two perpendicular light beams. The first beam (shown as a dashed line) is directed toward mirror 103 along direction of motion DMM of the interferometer. After reflecting from mirror the 103 and beam-splitter 102 portion of light of the first beam is directed to an observation station 105. The second beam (shown as a doted line) is directed perpendicularly toward a mirror 104 and after reflecting is directed to 105. Due to interference process, those two beams are forming interference fringes, which can be directly observed. Basic calculation showed that average speed of light beam parallel to the ether's wind is slightly lower than average speed of light beam perpendicularly to the ether's wind. Only in case that speed DMM is zero, the fringes are still. In all other cases for non-zero DMM, there should be observed left or right shifts of fringes. These shifts should depend of speed of motion of interferometer through the ether, and its orientation related to that speed, and they will serve as an indirect proof for existence of the ether. More detailed sources of information related to this mater are obtained in the most physics text books, scientific magazines, encyclopedias, internet, etc.

Experimental results of Michelson and Morley came as a big surprise and shock. They got “negative” results, that is, they did not get expected shifts of fringes, which should correlate with specific motion of interferometer though the space and ether. Their results did not confirm explicitly the existence of ether, so the fundaments of classical mechanics were shaken. As a solution for such a confusing situation in physics, there were proposed two opposite solutions. In order to save ether's idea, George F. Fitzgerald and Hendrik H Lorentz independently proposed idea that any body in motion (through the ether) is contracted in direction of motion for a factor which is compensating differences in average speeds of two light beams, thus annulling expected effect. That contraction should be considered as a real physical process. Internal distribution of light speeds in both arms and in both directions are nevertheless affected by ether's wind, thus, light speed is relative.

On the other hand, Albert Einstein accepted the Fitzgerald-Lorentz idea of contraction, but giving to it different meaning. He insisted that ether's idea should be abandoned, and he proclaimed the postulate of light speed constancy.

More detailed information about farther developments in physics following these “negative” experimental result can be found in sources cited above.

Today is generally accepted opinion that Michelson-Morley's experiments confirmed non-existence of ether, and that confirmed Einstein's postulate of light speed constancy. In reality, no part of their experimental process, nor results explicitly support either of rival options. Their interferometer provides ambivalent results, which are open for both of the two contradictory conceptions.

Because of ambiguity of Michelson-Morley's experimental results, their interferometer should be considered unsuitable for such a complex and delicate projects of detecting and exploring the ether's physical properties. Their ambivalent results obtained by their interferometer should be considered irrelevant and non-reliable base for any definite conclusion. Development of physics cannot rely on “free choice” between two ambivalent options. The only acceptable way in science is to developed such an experimental method and instruments which will provide explicit results. There must be eliminated any uncertainty, and reduce to minimum possible dilemmas and needs for arbitrary decisions by choices.

### SUMMARY

In accordance with one embodiment it was developed new type of interferometer with primary intention to be eliminated any possible ambivalence and uncertainty in interpretation of experimental results realized with this type of interferometers. In that meaning, here proposed two optical media two sectional L-shaped dual parallel beams interferometer is superior to Michelson-Morley's interferometer, because it provides unequivocal positive results as a base for strong conclusion in favor to ether's existence.

The main problem with Michelson-Morley's interferometer is that actual positive effects are neutralized, (masked) by physical contractions of interferometer in the direction of motions. There is not way to avoid Fitzgerald-Lorentz contractions, but two optical media two sectional L-shaped dual parallel beams interferometer has capability to neutralize negative effect of contractions on experimental results. Even more, with proposed embodiment, Fitzgerald-Lorentz contractions are deployed in a constructive, positive manner, that is, to reinforce expected positive experimental effects. These and other advantages of two optical media two sectional L-shaped dual parallel beams interferometers will be presented in the following drawings and the description.

### DRAWINGS

FIG. 1 shows a simplified version of the Prior Art of Mishelson-Morley's Interferometer.

FIG. 2 shows a two optical media two sectional L-shaped double parallel beams interferometer constructed in accordance with one embodiment.

FIG. 3 shows a sample of interference fringes generated by the two optical media two sectional L-shaped double parallel beams interferometer of FIG. 2.

FIG. 4 shows the three azimuthal orientations A, B, and C of 0°, 120°, and 240° related to the South-North orientation.

FIGS. 5a to 5c show the three 24 hrs orientations of the interferometer shown on FIG. 2 in accordance to the orientations shown on FIG. 4.

FIG. 6 shows a two optical media three sectional double parallel beams interferometer constructed as an additional embodiment.

FIGS. 7a to 7c show the 24 hrs orientations of the two optical media three sectional double beams interferometer shown on FIG. 6 in accordance to orientations shown on FIG. 4.

FIG. 8 shows a two optical media four sectional double parallel beams interferometer as an alternative embodiment.

FIGS. 9a to 9c show the three 24 hrs orientations of the two optical media four sectional double beams interferometer shown on FIG. 8 in accordance to orientations shown on FIG. 4.

FIG. 10 shows Earth globe with possible orientations of interferometer's planes related to Earth surface for different geographical locations.

FIG. 11 shows three typical fringe shift curves A1, B1, and C1, for three 24 hrs orientations of interferometers from FIGS. 5a to 5c, FIGS. 7a to 7c, and FIGS. 9a to 9c.

FIG. 12 shows three typical fringe shift curves A2, B2, and C2 from FIG. 11 transposed to a common 0 starting position.

FIG. 13 shows the three typical transposed fringe shifts curves A3, B3, and C3 for a P1, and P2 locations of interferometers of FIG. 10.

FIG. 14 shows the three typical fringe shift curves A4, B4, and C4 for the location Eh of the FIG. 10.

FIG. 15 shows typical relativistic expectation for all three types of interferometers from FIGS. 2, 6, and 8 for all three orientations, and for any geographical position.

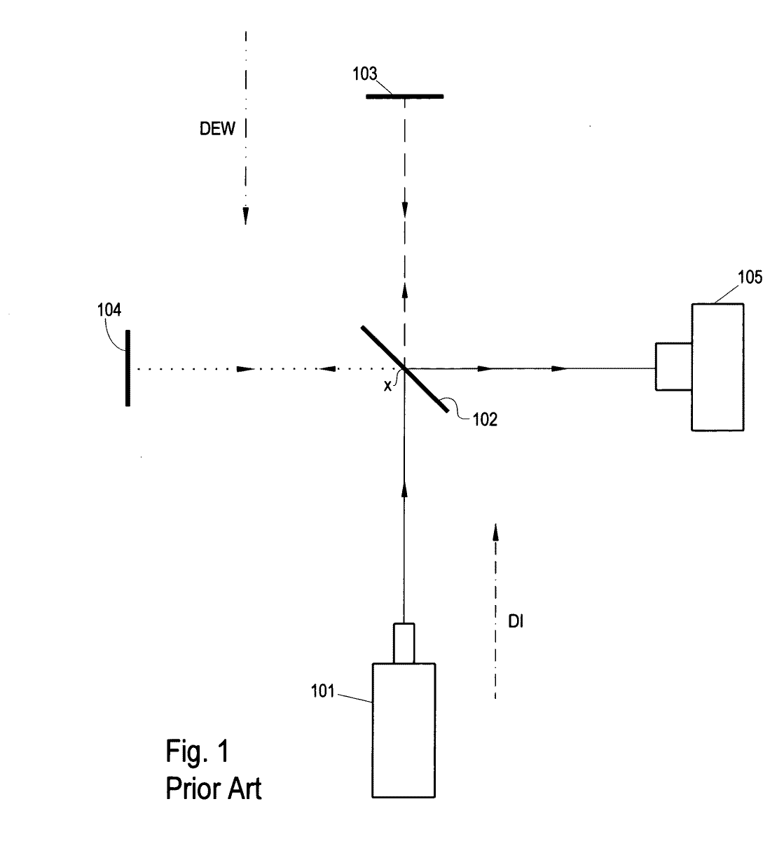

For the reason of simplicity, in above drawings are shown only minimum optical components for basic function of interferometers. Lasers, mirrors, beam-splitters, and optical windows are standard optical components used in interferometry. In addition there are shown elongated optically transparent media. For the same reason of simplicity, in above drawings are not shown secondary optical components, as they are the lenses, filters, polarizers, beam expanders, and more. Also, there are not shown mounting elements, rotational tables, temperature stabilizers and controllers, trembling stabilizers, and so on.

### DRAWINGS

### Reference Numerals

| PART NAME | | PART NAME | |
|---|---|---|---|
| 101 | source of monochromatic light | 102 | beam-splitter |
| 103 | mirror | 104 | mirror |
| 201 | laser | 202 | beam-splitter |
| 203 | beam-splitter | 204 | mirror |
| 205 | mirror | 206 | mirror |
| 207 | mirror | 208 | observation station |
| 209 | elongated optically transparent | 210 | elongated optically |
| | medium | | transparent medium |
| 211 | optical window | 212 | optical window |
| 213 | optical window | 214 | optical window |
| 601 | laser | 602 | beam-splitter |
| 603 | beam-splitter | 604 | beam-splitter |
| 605 | beam-splitter | 606 | beam-splitter |
| 607 | mirror | 608 | mirror |
| 609 | mirror | 610 | mirror |
| 611 | observation station | 612 | observation station |
| 613 | elongated optically transparent | 614 | elongated optically |
| | medium | | transparent medium |
| 615 | elongated optically transparent | 616 | optical window |
| | medium | | |
| 617 | optical window | 618 | optical window |
| 619 | optical window | 620 | optical window |
| 621 | optical window | | |
| 801 | laser | 802 | beam-splitter |
| 803 | beam-splitter | 804 | beam-splitter |
| 805 | beam-splitter | 806 | beam-splitter |
| 807 | mirror | 808 | mirror |
| 809 | mirror | 810 | mirror |
| 811 | mirror | 812 | mirror |
| 813 | mirror | 814 | mirror |
| 815 | observation station | 816 | observation station |
| 817 | elongated optically transparent | 818 | elongated optically |
| | medium | | transparent medium |
| 819 | elongated optically transparent | 820 | elongated optically |
| | medium | | transparent medium |
| 821 | optical window | 822 | optical window |
| 823 | optical window | 824 | optical window |
| 825 | optical window | 826 | optical window |
| 827 | optical window | 828 | optical window |

### DETAILED DESCRIPTION

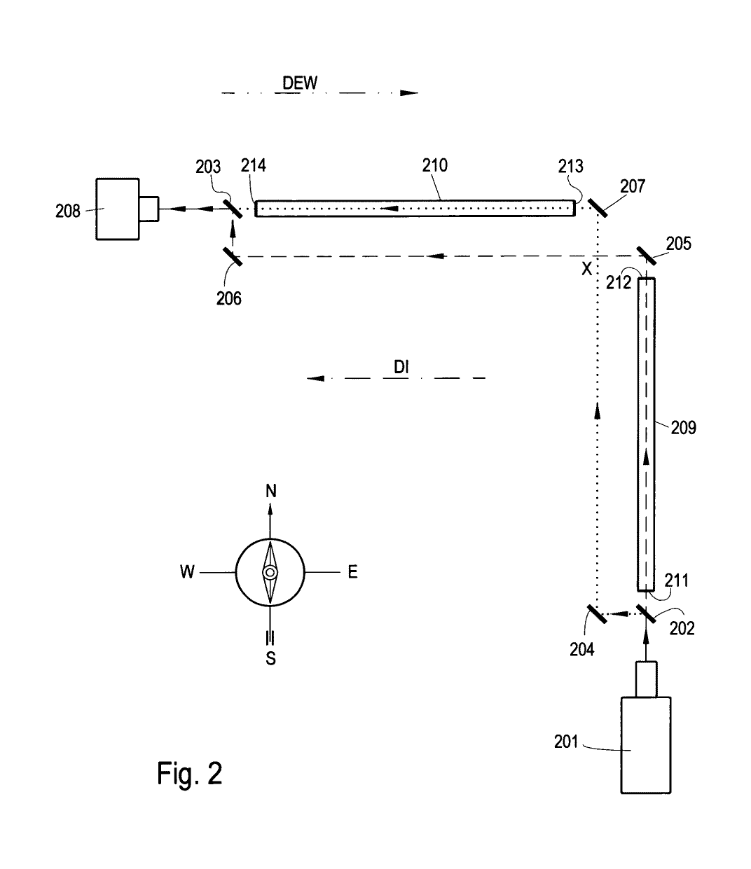

### FIG. 2—FIRST EMBODIMENT

FIG. 2 shows a basic structure of the two optical media two sectional L-shaped double parallel beams interferometer constructed in accordance with the first embodiment. This interferometer is designed to neutralize two unwanted negative effects on experimental results. The first negative effect is consequence of Fitzgerald-Lorentz contractions, which annul expected fringe shifts. The second one is so named Sagnac effect, which provokes unwanted unidirectional fringe shifts as a consequence of the Earth rotation.

Neutralization of these two unwanted effects is accomplished by several novelties implemented in design of the two optical media two sectional L-shaped double parallel beams interferometer. These novelties are, as follow:
(a) After a beam-splitter 202 splits light beam from a laser 201 into two mutually perpendicular components shown as the dashed and doted lines, a mirror 204 redirects doted light beam in direction which is parallel to the dashed light beam, alongside the first section of their optical paths.
(b) On half way of their optical paths both beams are redirected by the mirrors 205 and 207 perpendicularly to the previous direction keeping the two beams parallel alongside second section of their optical paths. FIG. 2 shows that redirection is to the left. Left or right redirection is arbitrary and is irrelevant for functioning of interferometer. At the end of their optical paths, both beams are rejoined by a mirror 206 and a beam-splitter 203, and redirected into observation station 208.
(c) Optical paths of the two parallel light beams are combined from two different optical media with different optical properties. In the first section of the interferometer the dashed light beam travels through an elongated optically transparent medium 209, while the doted beam travels through the air. In the second section is opposite, dashed beam travels through the air, while doted beam travels through an elongated optically transparent medium 210. The lengths of both transparent optical media are the same. Reason for involving two different optical media is that intensity of ether's wind through any optical medium depends of optical properties of that medium, such as index of refraction. In that way speeds of two light beams are differently affected by ether's wind during traveling through different optical media. From the relativist standpoint, there is not ether, nor ether's wind, so engagement of two different optical media is irrelevant.
(d) Elongated optically transparent media 209 and 210 can be made in the form of tubes from non-metallic material, desirable but not necessary to be transparent (glass, plastic, acrylic, plexiglass, and similar). The tubes are closed with the optical windows 211, 212 and 213, 214 respectively, and they are filled with optically transparent liquor (water, alcohol, mineral oils, gels, and similar). As an alternative option, instead of tubes filled with liquor, it can be used full profiled transparent rods made from high performance optical material with polished surfaces at the both ends. Another option is to be used optical resonant cavities.
(e) Both optical paths are parallel and unidirectional, that is, the light beams travel only in one directions, there is not reversal traveling as it is case with Michelson-Morley's interferometer.
(f) The both optical paths are of the same length, and if both sections where lined up in the same straight line, both paths would be optically equivalent. In that case there wouldn't be observed any shift of fringes under any circumstances, and this is the only situation when non-relativists and relativists would agree about experimental outcome.
(g) Situation is dramatically changing when two sections are forming L-shaped interferometer, because is coming to the point when non-relativist and relativist will irreconcilably disagree. From standpoint of the relativist, there is not ether, and geometrical form cannot affect optical equivalency of both paths. On the contrary, for non-relativist, two L-shaped optical paths are no more optically equivalent. Two different optical media are asymmetrically distributed in two perpendicular sections. Ether wind will affect differently two light beams, depend of orientation of interferometer related to ether's wind.
(h) Due to fact that both optical paths are parallel and of the same length, Fitzgerald-Lorentz contraction will affect the both paths equivalently, so negative effect on experimental results is neutralized. Even more, since optical paths are not optically equivalent, depend of direction of ether's wind contraction will affect positively, that is, will enforce fringe shifts.
(i) Sagnac effect is eliminated by crossing mutually the two optical paths of the two sections. As it's shown on FIG. 2, X is crossing point of he two light beams. In that way, two light beams are forming two opposite oriented loops. In the first section doted light beam is oriented clockwise, dashed is oriented counter clockwise. In the second section doted beam is oriented counter clockwise, and dashed beam is oriented clockwise.

The interferometer is mounted on a supporting means (not shown here), which enables horizontal rotation of interferometer and any non-horizontal orientation as well.

A compass shows preferred and recommended starting orientation for this type of interferometers related to South-North direction. DI arrow shows direction of motion of the interferometer, opposite arrow DEW shows direction of ether's wind.

The observation station 208 is supplied with optical systems where laser light beams are generating interference fringes. It's also supplied with computerized electronic devices (which can be wireless) for continual recording of fringe shifts, and with timers for automatic taking, transferring, and storing pictures of interference fringes. Also can be supplied with automated systems for analyzing the experimental results and graphical presentation.

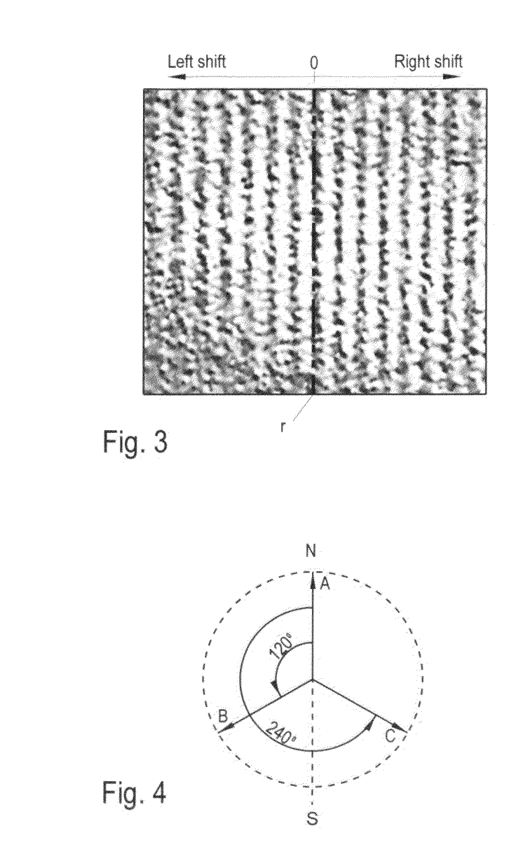

FIG. 3 shows sample of interference fringes with middle reference dash-doted line r for easier registering left or right shifts of interference fringes.

FIG. 4 presents three preferred orientations of the interferometer related to South to North direction. Azimuthal orientation A which is 0° is related to the direction alongside first section containing elongated optically transparent medium 209, and it's parallel to the South-North direction. Azimuthal orientations B and C are referring to the angles of 120° and 240° of the first section related to South-North direction respectively.

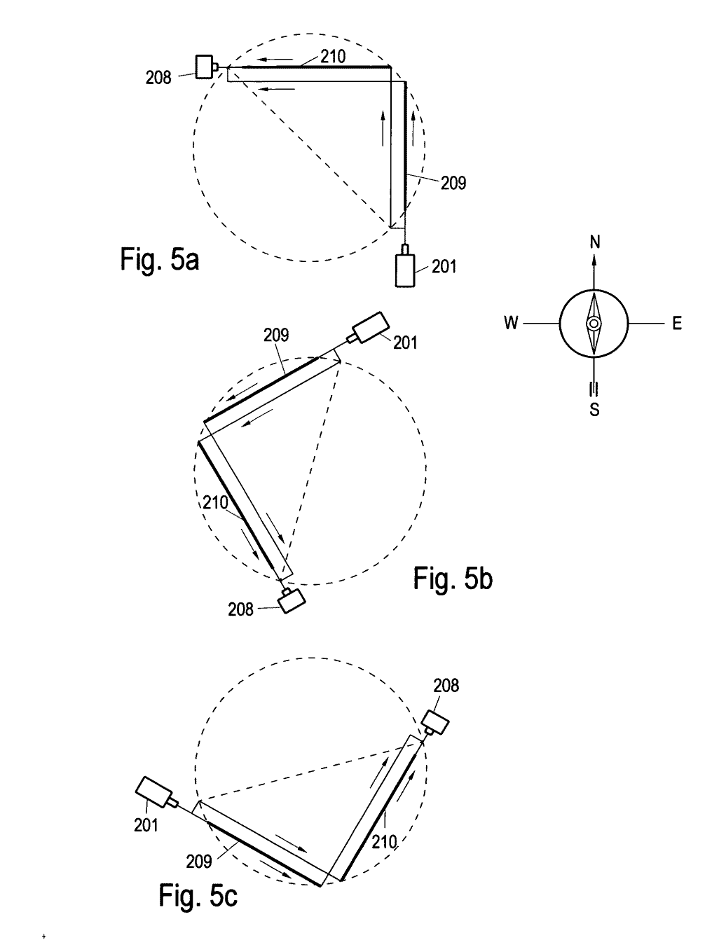

FIGS. 5a to FIG. 5c illustrate three orientations of the two sectional L-shaped interferometer in accordance with azimuthal map from FIG. 4.

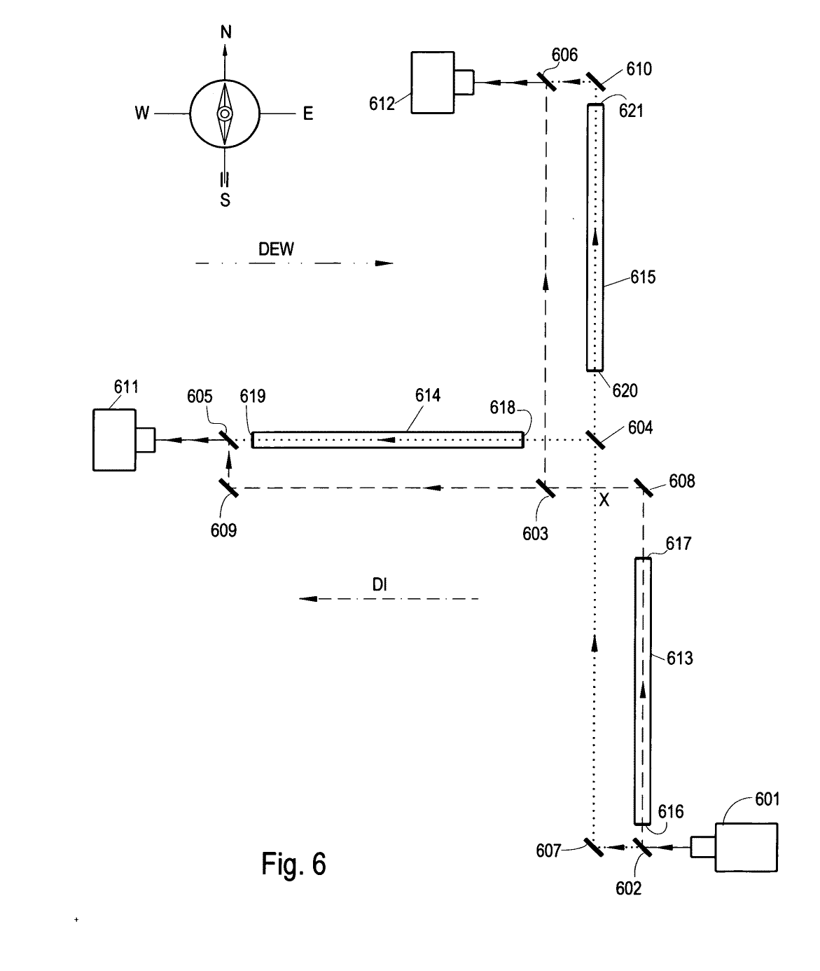

FIG. 6 shows two optical media the three sectional double parallel beams interferometer constructed in accordance with additional embodiment. This three sectional interferometer is actually combination of two independent interferometers. The first interferometer is related to the first section containing optical medium 613, and section two containing optical medium 614. The second interferometer is related again to the first section containing optical medium 613 and section three containing optical medium 615. Both interferometers share the first section, with optical medium 613, while the second and third sections are mutually perpendicular. All three sections are of the same lengths. The first interferometer is actually two optical media two sectional L-shaped type of interferometers described above, and it's serving as a master interferometer. The second linear interferometer is added as a control, referential interferometer. The both optical paths for the second interferometer are equivalent, and there will not be shifts of interference fringes at observation station 612. This additional, control interferometer is added to demonstrate practically that in space filled with ether, small differences in geometrical shape can make extraordinary differences in experimental results.

Differences in experimental results for the two interferometers in FIG. 6 are easy to explain as an influence of ether's wind, but there is not satisfactory explanation from relativistic point of view.

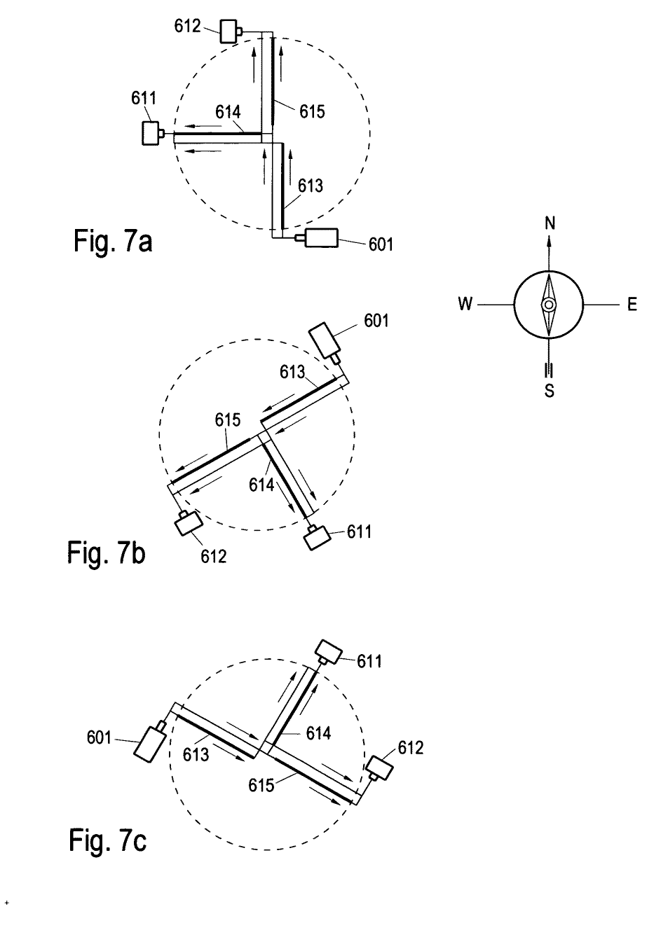

FIGS. 7a to 7c illustrate three orientations of the three sectional double parallel beams interferometer in accordance with azimuthal map from FIG. 4.

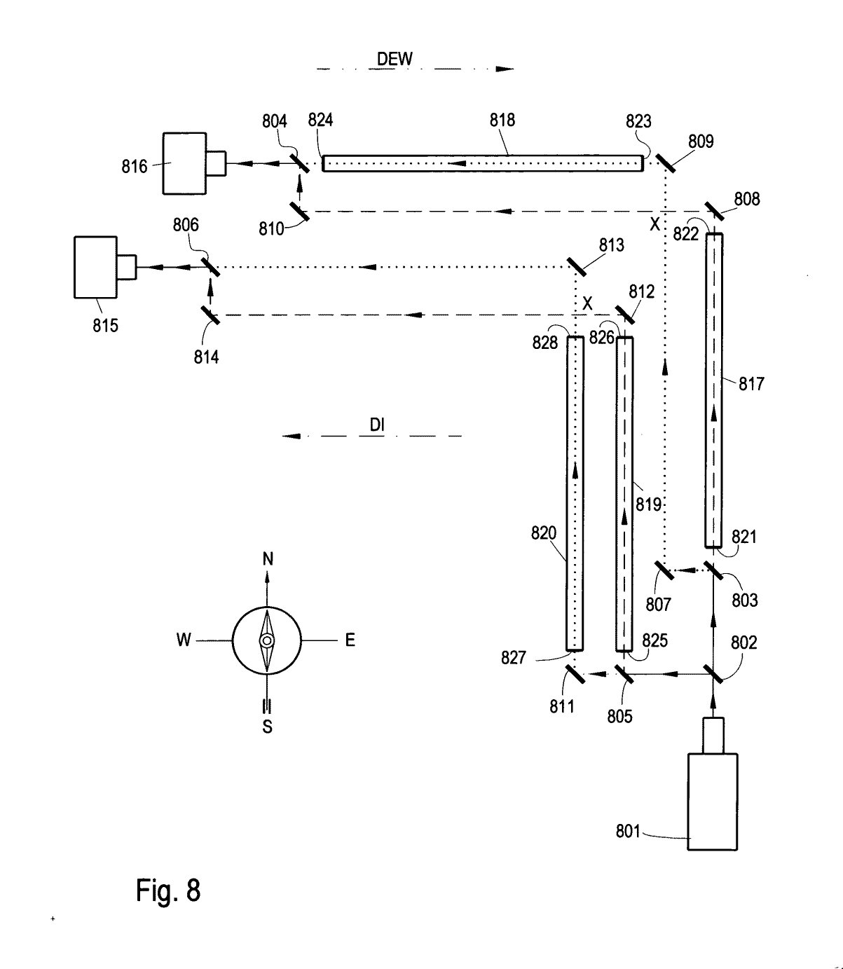

FIG. 8 shows two optical media four sectional double L-shaped interferometers constructed in accordance with alternative embodiment. In order to confront and contrast to maximum two irreconcilable stands in regard to the ether's existence, there are two L-shaped interferometers set parallel next to each other. They both share the same laser 801 and a beam-splitter 802. The first L-shaped interferometer, comprising the beam-splitters 803, 804, mirrors 807, 808, 809, and 810, the elongated optically transparent media 817, 818, and an observation station 816, is the master interferometer. The second interferometer comprising the beam-splitters 805, 806 mirrors 811, 812, 813, and 814, the elongated optically transparent media 819 and 820, and an observation station 815, is passive, control interferometer. That interferometer is permanently characterized by “negative results”, no fringe shifts can be observed. Geometrical configuration of both interferometers is the same, the only difference is that elongated optical media 819 and 820 are parallel, they are both set in the first section, while optical media 817 and 818 are mutually perpendicular, set in different sections. From relativistic point of view both interferometers are optically equivalent, neither observation station 816 nor 815 should register any shift of interference fringes. In reality, minor difference in configuration and geometrical distribution of optical component will provoke great impact on experiment results. Displacement of the elongated optical medium 820 from optical line between elements 813 and 806 to the optical line between the elements 811 and 813 will provoke inactivation of second, control interferometer. In that way, two almost identical interferometers, set in identical conditions will show great differences in experimental results. For non-relativist physicists these differences are normally expected as the influence of ethers wind, thus, can be considered as the experimental proof of ether's existence. On the contrary, relativists will see these difference as an anomalous phenomena for which they cannot offer satisfactory explanation.

Both interferometers from FIG. 6 and FIG. 8 are resistant to Fitzgerald-Lorentz contraction, and Sagnac effect as well.

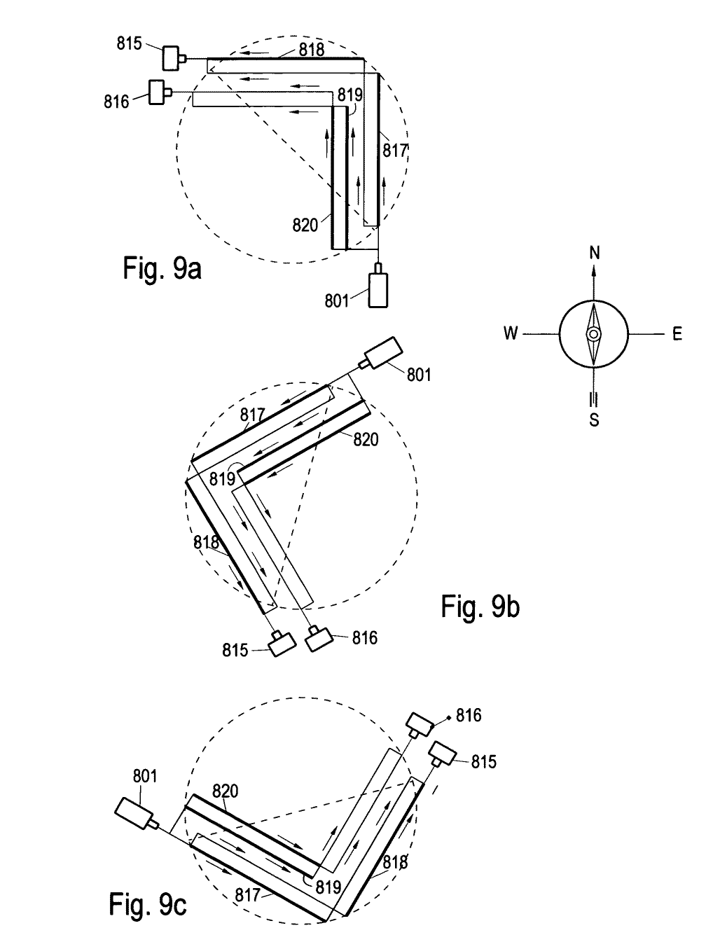

FIGS. 9a to 9c illustrate three orientations of two optical media four sectional double L-shaped interferometers in accordance with azimuthal map from FIG. 4.

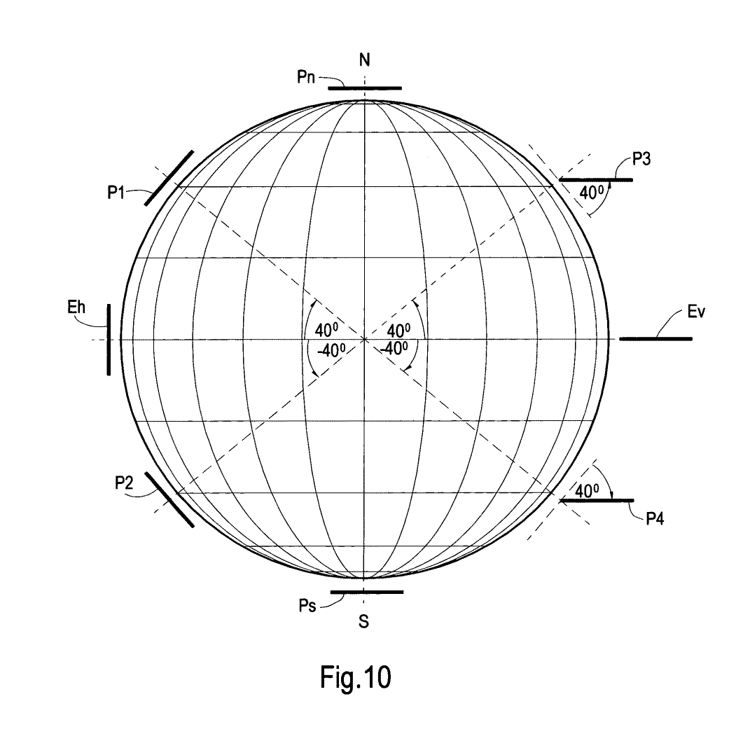

FIG. 10 shows variety of geographical locations, and orientations related to the Earth surface of a basic plane of double parallel beam interferometers. Experimental results are affected both by locations and orientations of interferometers.

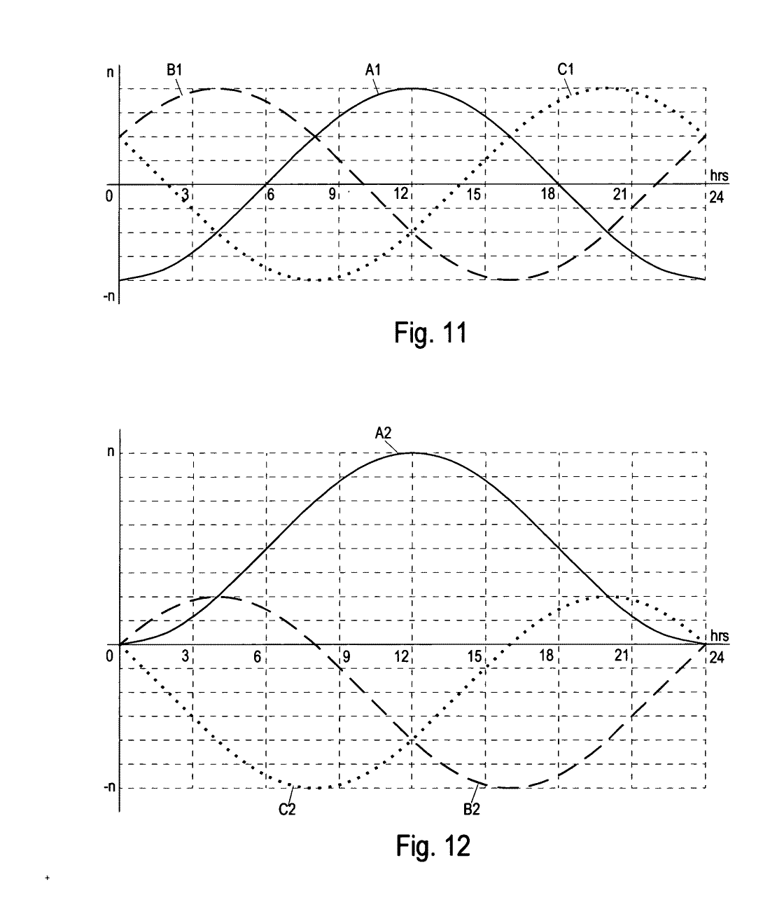

FIG. 11 shows typical curves of shifts of interference fringes for L-shaped interferometers from FIG. 2, FIG. 6, and FIG. 8. The curve A1 presented with continuous line is presenting fringe shifts during 24 hrs cycle of observation for A orientation of 0° azimuthal angle of interferometers in accordance with FIGS. 4, 5a, 7a, and 9a. The curve B1 presented as a dashed line is presenting 24 hrs fringe shifts for B orientation of 120°, in accordance with FIGS. 4, 5b, 7b, and 9b. The doted curve C1 presents C orientation of 240° azimuthal angle of interferometers in accordance with FIGS. 4, 5c, 7c, and 9c.

FIG. 12 with A2, B2, and C2 present curves from FIG. 11 transposed to the common starting 0 position. It is more practical to register relative fringe shifts than to follow their absolute positions. As it is shown on FIG. 3, we can arbitrarily chose that right shifts of fringes related to vertical reference line r are positive (n), presented above x coordinate line, and respectively, left shifts as a negative (−n). Both sets of curves shown on FIG. 11 and FIG. 12 are related to an interferometer planes perpendicularly oriented to the Earth rotational axis. Only positions Pn and Ps at the Earth poles satisfying conditions that interferometers plane can be both horizontal to the Earth surface, and perpendicular to rotational axes. All other locations (FIGS. 10, P3, P4, and Ev) of interferometer planes are perpendicular to the Earth axis only for non-horizontal local orientation.

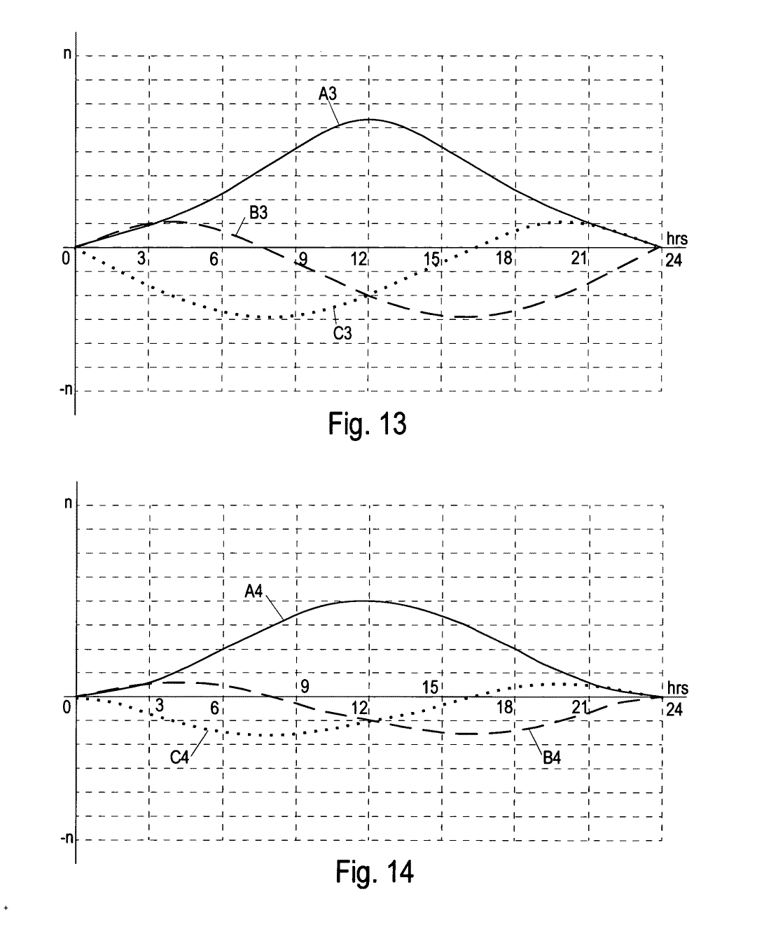

FIG. 13 with A3, B3, and C3 present relative fringe shifts for the horizontal orientation of interferometer planes for the locations P1 and P2 of FIG. 10. It can be noted that for horizontally oriented interferometers, efficiency is lower for the locations closer to the equator.

FIG. 14 with A4, B4, and C4, shows that the lowest efficiency of interferometer is for locations Eh at equator, for horizontal orientation. On the other hand, vertical equatorial orientation Ev is preferred because of most extensive 24 hrs cyclic modulation of experimental results due to the Earth rotation.

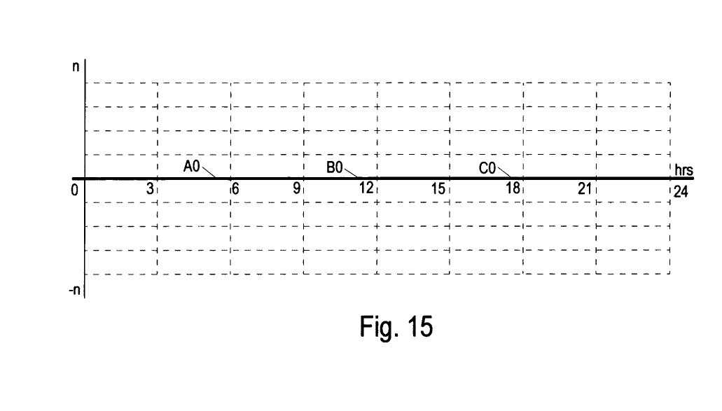

As a contrast to FIGS. 11 to 14, FIG. 15 present diagram for shifts of interference fringes from the relativistic point of view, that is, as per them, results will be always negative, “0”, no mater of what type of interferometer, orientation, or geographical position is involved in experiments. Yet such a stand point faces one big obstacle: diagrams from FIGS. 11 to 14 are experimentally already proven facts. There is not satisfactory relativistic explanation for fact that experimental results depend on geometrical configuration, azimuthal orientation, geographical position, and period of day.

In regard to influences of temperature variations and fluctuations on experimental results and necessary steps to realize temperature control and stabilization, relativists should be more concerned about that problem than non-relativists. During 24 hrs day-night cycle, temperature variation coincidentally correlate with 24 hrs cycle of intensity and orientation of ether's wind. Since both optical paths, according to relativist, are equivalent, if temperature in experimental room is well homogenized, then any temperature variation should simultaneously and identically affect both light beams. In other words, homogenously distributed temperature variations wouldn't provoke shifts of fringes. In order to make situation harder to relativist, if there is any concern about influence of temperature variations on shifts of fringes, then can be used three sectional model of interferometer from the FIG. 6, or even better, if it was used four sectional double L-shaped interferometers from the FIG. 8. Since both interferometers of FIG. 8 are almost identically geometrically shaped, positioned next to each other, any difference in interference shifts would be hard to explain as an influence of temperature variations, especially if there is taken good care about temperature stabilization.

As an additional method for eliminating any possible relativistic concern in regard to 24 hrs correlation between experimental results end temperature variations, interferometer could be used continuously during 72 hrs, that is 3×24 hrs cycles in row. Every 24 hrs interferometer will be directed in new azimuthal orientations, as it shown on FIG. 4, FIGS. 5a to 5c, FIGS. 7a to 7c, and FIGS. 9a to 9c. It is clear that influence of temperature variations on interferometer cannot be related to azimuthal orientation of interferometer.
1. If there is any influence of temperature variations, experiment results should follow the same 3×24 hrs pattern independent of orientation and geographical position.
2. If during three days experimental results follow three different patterns, which correlate with azimuthal orientations and geographical positions, then it is obvious that fringe shifts are not related to temperature variations.

Supporting means for all above interferometers can be earth-laboratory based, or can be mounted on water floating platforms. Also can be mounted on magneto-electrical fields levitating platforms. In that case, instead of 24 hrs Earth rotational cycles, fully rotational cycles can be realized in desired short period of time.

### Operation

Detection of cosmical ether is based on registering differences in speeds of two parallel laser beams passing through two different optical media, and in different directions related to direction of Earth motion through the ether. It is presumed that so named ether's wind is affecting differently the relative speeds of light beams in different optical media of interferometer, causing shifts of interference fringes. Observation and registration of shifts of interference fringes and correlating them with specific motion of interferometer through space and ether for different orientations of experimental set, and geographical locations are part of experimental method.

### Advantages

All three two optical media L-shaped versions of double parallel beams interferometers described above offers experimental method which completely undermine and invalidate experimental results obtained by Michelson-Morley's type of interferometers.

### CONCLUSION, RAMIFICATIONS, AND SCOPE

Interferometers can be used as a very powerful tool in astronomy, especially can be set as array of interferometers, network connected. Due to today's advances in the domains of optics, photonics, and crystallography, interferometer can be realized in compact, miniature form, but also as very large systems. Interferometers can be also carried by any form of transportation, or to be space station based.

The use of two optical media double parallel beams interferometry is not limited only on detection and confirmation of ethers existence, but also in exploring of its physical properties in relation to numerous open questions in today's science. Invisible dark ether is probably key solution for invisible missing dark mater problem. Considering four natural forces as the physical activities of ether, search for gravity waves can be performed in much efficient way by applying modified and adapted above described interferometers.

Above description should not be construed as limiting the scope of the embodiments, but rather as providing illustrations of some of the presently preferred embodiments. For example, two L-shaped interferometers can be combined as three sectional, three-dimensional, three-legged, interferometer sharing the same laser, and one common section.

Thus the scope of embodiments should be determined by appended claims and their legal equivalents, rather than by examples given.

I claim:

1. Two optical media two sectional L-shaped double parallel beams interferometer, providing means and methods for neutralizing the disturbance provoked by Fitzgerald-Lorentz contractions, and Sagnac effect on experimental results, especially in the applications of experimental detection and confirmation of existence of ether by observing and registering the shifts of interference fringes provoked by differences in influence of ether's wind on two parallel unidirectional laser beams traveling through two optical paths combined of two different optical media each, comprising:
a. a laser providing monochromatic, coherent laser beam of stabilized frequency,
b. a first set of beam-splitter and mirror at the beginning of the first section of said interferometer, splitting said laser beam into two separate beams, and directing them as said two parallel, unidirectional laser beams, along said first section of said L-shaped interferometer,
c. set of two mirrors at the end of said first section and beginning of the second section, redirecting said two parallel unidirectional beams in direction perpendicular to previous direction, along said second section, forming two parallel two sectional L-shaped optical paths,
d. two elongated optically transparent media of the same length, second set of beam-splitter and mirror at the end of said second section, merging said two parallel beams, and redirecting them into an observation station where said shifts of interference fringes are observed, recorded, transmitted, analyzed, and graphically presented,
e. where the first optical media is set alongside said first section as a part of said optical path of the first laser beam, whereas the second optical media is set perpendicularly to the first one, alongside of said second section as an optical path of the second laser beam,

2. The L-shaped interferometer of claim 1 wherein said neutralizing the disturbance of said Fitzgerald-Lorentz contraction on said experimental results by providing said two parallel unidirectional optical paths of the same length, which are equally affected by said contraction.

3. The L-shaped interferometer of claim 1 wherein said neutralizing Sagnac effect on said experimental results by crossing said two optical paths performing set of two optical loops opposite oriented, annulling any rotary effect, including Earth rotation on said experimental results.

4. The L-shaped interferometer of claim 1 wherein said two laser beams traveling along said L-shaped two parallel optical paths combined of two perpendicular sections each, and combined of two different optical media, thus ether's wind will affect differently the speeds of light of said two parallel laser beams, provoking shifts of interference fringes.

5. The L-shaped interferometer of claim 1 wherein said two optical media, applying air as one of said two optical media, and another one in the form of elongated optically transparent medium applying tubes filled with optically transparent liquor, said tubes closed on both sides with optical windows, or rods from solid optically transparent media with polished both ends applied as said elongated optically transparent media.

6. The L-shaped interferometer of claim 1 wherein said two optical paths composed from optical components forming said two parallel two sectional L-shaped optical paths in way that said first beam travels alongside said first section through the first elongated optical medium continuing alongside said second perpendicular section to travel through air, and vice versa, said second beam travels alongside said first section through the air, and then, continuing alongside said second perpendicular section to travel through second elongated optical medium.

7. The L-shaped interferometer of claim 1 wherein said two parallel unidirectional laser beams traveling through said two parallel two optical media L-shaped optical paths will be differently affected by said ether's wind for different orientations and geographical locations of said L-shaped interferometer.

8. The L-shaped interferometer of claim 1 wherein said different influence of said ether's wind on said two parallel unidirectional laser beams will produce non-zero, positive, observable and registrable shifts of interference fringes.

9. The L-shaped interferometer of claim 1 wherein said observation station is supplied with optical and electronic systems for observing, recording, transmitting, analyzing, and graphical presentation of the experimental results related to shifts of interference fringes, where said shifts of interference fringes are caused by different influence of said ether's wind on speeds of said two parallel unidirectional laser beams, where results of analyzed experimental data would serve as unequivocal support for hypothesis of existence of said ether.

10. Two optical media three sectional double parallel beams interferometer providing means and methods for neutralizing the disturbance provoked by Fitzgerald-Lorentz contractions, and Sagnac effect on experimental results, especially in the applications of experimental detection and confirmation of existence of ether by observing and registering the shifts of interference fringes provoked by differences in influence of ether's wind on two sets of two parallel unidirectional laser beams traveling through two sets of double optical paths combined of two different optical media each, comprising:
f. two interferometers, one is two optical media two sectional L-shaped double parallel beams interferometer, another one is two optical media two sectional linear-shaped double parallel beams interferometer, both sharing the first section including laser, in that way forming said three sectional interferometer,
g. a first set of beam-splitter and mirror for splitting the laser beam into two separate beams, and directing them as said double parallel, unidirectional laser beams, along said first section,
h. a second set of two beam-splitters and one mirror, are splitting said two laser beams into four laser beams, forming two mutually perpendicular unidirectional pairs of double parallel laser beams, the first pair of double parallel laser beams traveling alongside second section, perpendicularly to said first section, and second pair of double parallel laser beams traveling along third section,
i. the third set of beam-splitter and mirror at the opposite end of said second section are rejoining and redirecting said first pair of laser beams into first observation station where they are interfering and forming the first set of interference fringes,
j. at the end of said third section, fourth set of beam-splitter and mirror are rejoining and redirecting said second pair of laser beams into second observation station where they are interfering and forming second set of interference fringes,
k. three elongated optically transparent media of the same length, positioned one media per section, forming T-shape,

11. Two optical media three sectional double parallel beams interferometer of claim 10 wherein said neutralizing the disturbance of Fitzgerald-Lorentz contraction on said experimental results by providing two sets of double parallel unidirectional optical paths of the same length, which are equally affected by said contraction.

12. Two optical media, three sectional double parallel beams interferometer of claim 10 wherein said neutralizing the Sagnac effect on said experimental results by crossing on half way double parallel laser beams for both sets of optical paths.

13. Two optical media three sectional double parallel beams interferometer of claim 1 wherein said comprising two interferometers, the first one, said two optical media two sectional L-shaped double parallel beams interferometer is the main, active, master interferometer, whereas said two optical media two sectional linear-shaped double parallel beams interferometer is auxiliary, passive, control interferometer, both sharing the optical components and optical media of said first section including laser,

14. Two optical media three sectional double parallel beams interferometer of claim 13 wherein said comprising two interferometers, one said L-shaped, and another one said linear-shaped, enabling opportunity for immediate comparison and confrontation of two incompatible antagonistic non-relativistic vs. relativistic expectations of said experimental results.

15. Two optical media three sectional double parallel beams interferometer of claim 13 wherein said antagonistic expectation of experimental results, that according to relativistic expectations both L-shaped and linear-shaped interferometers will show the same, negative results, absent of shifts of interference fringes, because there is nothing in space to provoke them, whereas according to non-relativistic expectations, only linear-shaped, control interferometer will show absence of shifts of interference fringes, while L-shaped interferometer will show shifts of interference fringes due to influence of ether's wind.

16. providing means and methods for neutralizing the disturbance provoked by Fitzgerald-Lorentz contractions, and Sagnac effect on experimental results, especially in the applications of experimental detection and confirmation of existence of ether by observing Two optical media four sectional double L-shaped double parallel beams interferometer and registering the shifts of interference fringes provoked by differences in influence of ether's wind on two sets of two parallel unidirectional laser beams traveling through two sets of double optical paths combined of two different optical media each, comprising:
l. two L-shaped double parallel beams interferometers, both two optical media, both two sectional, mutually parallel, the first said interferometer functioning as a main, active, master interferometer, the second one functioning as an auxiliary, passive, control interferometer, both sharing the same laser,
m. a beam-splitter for splitting the laser beam into two separate beams, directing them toward two additional sets of beam-splitters and mirrors forming four parallel unidirectional laser beams directing them along two parallel first sections with two parallel beams per each section,
n. at the end of both first sections, four mirror, one per laser beam, redirecting all said four laser beams perpendicularly to previous direction, keeping them parallel alongside two second sections, which are perpendicular to said two first sections,
o. at the end of said two second sections, two sets of beam-splitters and mirrors are rejoining said four laser beams into two laser beams and redirecting them into two separate observation stations, where laser beams are forming two independent sets of interference fringes,
p. four elongated optically transparent media of the same length, positioned so that for said main, active interferometer one said elongated optically transparent medium is set alongside said first section, second one perpendicularly alongside said second section, and for auxiliary, control interferometer, both said elongated optically transparent media are set parallel alongside said first or alongside said second section,

17. Two optical media four sectional double L-shaped double parallel beams interferometer of claim 16 wherein said neutralizing the disturbance of Fitzgerald-Lorentz contraction on said experimental results by providing two parallel sets of L-shaped said double unidirectional optical paths of the same length, equally affected by said contraction.

18. Two optical media four sectional double L-shaped double parallel beams interferometer of claim 16 wherein said neutralizing the Sagnac effect on said experimental results by crossing on half way said double parallel laser beams for both sets of optical paths.

19. Two optical media four sectional double L-shaped double parallel beams interferometer of claim 16 wherein said comprising two said interferometers, both L-shaped, enabling opportunity for immediate comparison and confrontation of two incompatible antagonistic non-relativistic vs. relativistic expectations of said experimental results.

20. Two optical media four sectional double L-shaped double parallel beams interferometer of claim 16 wherein said antagonistic expectation of said experimental results, that according to said relativistic expectations both L-shaped interferometers will show the same, negative results, absent of shifts of interference fringes, because there is nothing in space to provoke them, whereas according to said non-relativistic expectations, only said auxiliary, control interferometer will show absence of shifts of interference fringes, while said main, active interferometer will show shifts of interference fringes due to influence of ether's wind.
